(19) United States
(12) Patent Application Publication
(10) Pub. No.: US 2004/0119753 A1
(43) Pub. Date: Jun. 24, 2004

(54) Scrolling through data in a graphical user interface

(76) Inventor: Peter Zencke, Walldorf (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/324,095

(22) Filed: Dec. 20, 2002

(51) Int. Cl. G09G 5/00

(52) U.S. Cl. 345/786; 345/833

(57) ABSTRACT

A graphical user interface (GUI) element for simulating scrolling a display pane that displays a visible set of data records. A set of data records are selected from a data store and the visible set of data records include data records from the selected set of data records. The GUI element includes a scroll bar control element corresponding to the display pane. The scroll bar control element is operable to update the visible set of data records in response to a scroll bar control event. In the GUI element, only a subset of the selected set of data records are received by the user interface element.

### TECHNICAL FIELD

This invention is directed to an element for use in graphical user interfaces, and more particularly, to a scroll bar element for controlling the graphical display of data.

### BACKGROUND

A graphical user interface (GUI) is an interface to a computer software application that takes advantage of graphical capabilities of computer systems. A GUI typically includes various elements that display information to and/or receive input from a user. GUI elements are sometimes referred to as widgets and may include custom user interface components or standard components such as, for example, scroll bars, push buttons, check boxes, radio buttons, and text panes. Most computer software applications available today provide GUIs to efficiently interact with users.

GUIs are particularly useful in displaying representations of data. For example, a table of numbers may be displayed using various techniques including, for example, lists, bar charts, scatter plots, and line graphs. These graphical representations may assist users in viewing, manipulating, and visualizing the data to more easily recognize trends and analyze patterns within the data.

In business applications, data is typically kept in a data store such as, for example, a relational database management system (RDBMS), a flat file, a spreadsheet, or a data cache system. A set of data matching certain conditions may be selected from the data store to process, display, or otherwise manipulate the data. The selection of data from a data store may be an expensive operation. In an RDBMS system, selection performance may be improved by indexing some or all of the attributes in the RDBMS and by tuning the system. Even in an optimized system, data selection operations still may be time-consuming.

To prevent repeated data store queries the selected data obtained from the data store may be buffered, i.e., the data may be stored temporarily in main memory for further use. When the data is buffered, the next time the data is needed, it may be read from the buffer instead of requiring a new selection from the data store. The buffered data may be used until the data in the data store changes. Then, the buffered data is not up to data any more and a new selection may be performed on the data store.

For example, a customer relationship management (CRM) system stores various customer information in a data store. A CRM application may allow a user to select customer records from the CRM data store that meet certain criteria. The selected records may be displayed for a user to examine, for example, in a list user interface element. If the number of records is too large to display at one time, a scroll bar element may be used to scroll the selected data through the visible pane in the list user interface element. If a large number of records are selected, the time needed to load data across the network may be great.

### SUMMARY

In one general aspect, a user interface element for simulating scrolling is provided. The user interface element includes a display pane operable to display a visible set of data records and a scroll bar control element corresponding to the display pane. The visible set of data records include data records from a selected set of data records from a data store. The scroll bar control element is operable to update the visible set of data records in response to a scroll bar control event. Only a subset of the selected set of data records are received by the user interface element. In some implementations, the subset of the selected set of data records include only data records displayed in the display pane.

The scroll bar control element also may include a slider button. The slider button may be sized based on the number of data records in the selected set of data records. The number of data records may be determined in logarithmic time using an augmented traversable tree structure. Each node of the traversable tree structure may be augmented with a counter that may be used to determine the number of data records. This information may be obtained by querying the data store.

In another general aspect, a data query tool includes a data store operable to store data records, a data query software application operable to query the data store to identify data records satisfying a query statement, and a user interface for displaying identified data records. The user interface includes a display pane operable to display a visible set of data records, and a scroll bar control element corresponding to the display pane. The visible set of data records includes a subset of the identified data records. The scroll bar control element is operable to update the visible set of data records in response to a scroll bar control event. A subset of the identified data records is received by the user interface.

In another general aspect, a method for simulating scrolling in a graphical user interface includes providing a list pane operable to display a visible set of data records in a graphical user interface, providing a scroll bar control element corresponding to the list pane, querying a data store to identify a set of data records satisfying a query statement, receiving a subset of the identified data records including the visible set of data records, and displaying the visible set of data records. The scroll bar control element is operable to update the visible set of data records in response to a scroll bar control event.

The details of one or more implementations are set forth in the accompanying drawings and the description below. Other features and advantages will be apparent from the description and drawings, and from the claims.

### DESCRIPTION OF DRAWINGS

FIG. 1 is a block diagram of a software system using a graphical user interface (GUI) providing a list user interface element that simulates scrolling.

FIG. 2 is a block diagram of a software system that selects data from a data store and displays a portion of the selected data in a GUI.

FIG. 3 is a screenshot of a GUI displaying a bar graph with a simulated scrolling list user interface element.

FIG. 4 is a flowchart of a process to simulate scrolling in a list graphical user interface element.

### DETAILED DESCRIPTION

In a graphical user interface (GUI), a list element typically receives a set of data to be displayed. If the set of data is larger than the display capacity, the GUI displays only a portion of the set of data and provides a scroll bar so that the user may scroll the data through the visible pane to view entire set of data. For example, if a business application selects 100 records from a data store and displays them in a list element that may only display 15 records at a single time, the first 15 records are shown. A user may actuate a scroll bar to change which records are displayed. By clicking a down arrow, the list element updates the display to show, for example, data records 2-16. A typical list element loads all data to be displayed and then updates the display in response to user interface events generated through a corresponding scroll bar; however, when a large number of data records are selected, it may take a long time to load the data into the list element, though only a small number of records are displayed at any given time.

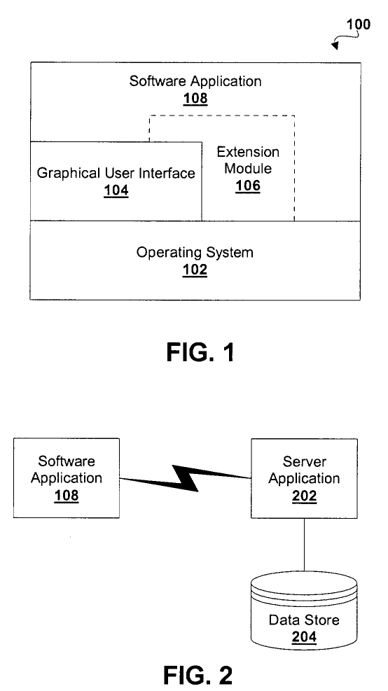

Referring to FIG. 1, software environment 100 includes an operating system 102 providing an interface to hardware input and output devices such as, for example, a keyboard, mouse, printer, display, and network. A graphical user interface (GUI) module 104 provides a library of routines used to implement a GUI. A GUI module 104 also may be provided as part of operating system 102. For example, Microsoft Windows is sold as an operating system; however, it includes an operating system 102 and a GUI module 104. The software environment 100 may include various libraries or extension modules 106 that may be used by a software application 108. In this example, the GUI module 104 uses the underlying operating system 102 to provide a graphical interface for software application 108. Software application 108 also may use the operating system 102, the GUI module 104, and extensions provided by extension module 106. For example, the extension module 106 may provide a scroll bar widget supporting simulated scrolling to allow the software application 108 to provide list GUI elements with simulated scrolling.

The GUI module 104 includes a list element that receives and displays a set of data records in a list pane. If there are more data records than may be displayed in the list pane, the list element instantiates a scroll bar control element. The scroll bar control element may be used to selectively scroll all of the data records through the list pane. The scroll bar control element includes a slider button situated in a horizontal or vertical scroll bar control element the slider button may be moved up and down to scroll through records loaded into the list element. In some business applications, the number of records to be displayed may be very large. In general, the larger the number of records, the more time that it takes to load the data records from a data store, across a communications medium, to the list element. If a user does not wish to view all of the data records, but only to confirm that the first few selected data records look correct, the system may still load all of the data records into the list element.

Referring to FIG. 2, a software application 108 provides a GUI that submits a query to a server application 202. The server application 202 accesses the data store 204 and returns records satisfying the query to the software application 108. In some implementations, the server application 202 is a data cache such as the fast data cache described in WO 02/061612 A2, titled “Data Structure for Information Systems” and published Aug. 8, 2002, and WO 02/061613, titled “Database System and Query Optimiser” and published Aug. 8, 2002, each of which is hereby incorporated by reference in its entirety for all purposes.

The software application 108 and the server application 202 may be implemented using any conventional application development environments. The software application 108 and the server application 202 may be configured to run on the same processor, or on separate processors coupled to one another using any communications mechanism such as, for example, a microprocessor bus, a local area network, and/or a wide area network. The server application 202 provides a mechanism to access data records in data store 204.

In some implementations, the data store 204 stores a set of data records, each data record having one or more attributes. The data store 204 indexes each attribute in a tree structure, such as, for example, an AVL tree structure, a B* tree structure, or a red-black tree structure. Each node of the tree structure is augmented with a counter that stores an indication of the number of nodes below that node in the tree. For example, the counter may store the exact number of nodes below the node in the tree or any other number indicative of the number of nodes associated with the instant node. The tree structure indexes may be traversed to identify data records matching a condition. Using the counter augmentation, the system may determine the number of data records matching the condition in logarithmic time.

The data store 204 accepts queries that may be formulated in a query language, such as the structured query language (SQL). For example, the following SQL statement selects records from a customer data store with a last name of “SMITH”:

SELECT*FROM customer_data WHERE last_name=“SMITH”.

This statement selects all attributes of the records in the data store named “customer_data” where the attribute “last_name” is equal to “SMITH.” In there are a very large number of matching records, the select statement may take a long time to execute and may require a large amount of network activity to transfer the matching records. A data store 204 may be provided that is augmented to quickly determine the number of hits and that allows a client application to select a small number of records matching the condition. For example, the data store 204 described above traverses the tree structured indexes, using the counters to quickly determine the number of matching records. The data store 204 then traverses the matching nodes to provide the selected records.

The counter augmentation also may be used to begin traversing the matching nodes at any position within the set of matching data records. For example, the data store 204 may begin traversing the set of matching data records at an arbitrary position, such as, for example, the 16^{th} matching data record. The system traverses the index tree structures, using the counter augmentation to identify the 16^{th} matching data record and then begins traversing the tree structure in order to return the number of requested matching data records.

The SQL select statement shown above may be modified to select only a portion of the matching records. For example, the following select statement returns 20 matching records beginning with the 16^{th} record:

SELECT*FROM customer_data WHERE last_name=“SMITH” LIMIT 16, 20.

Using the data store 204 described above, the system may quickly determine the number of matching records as well as quickly select a subset of the matching records to display.

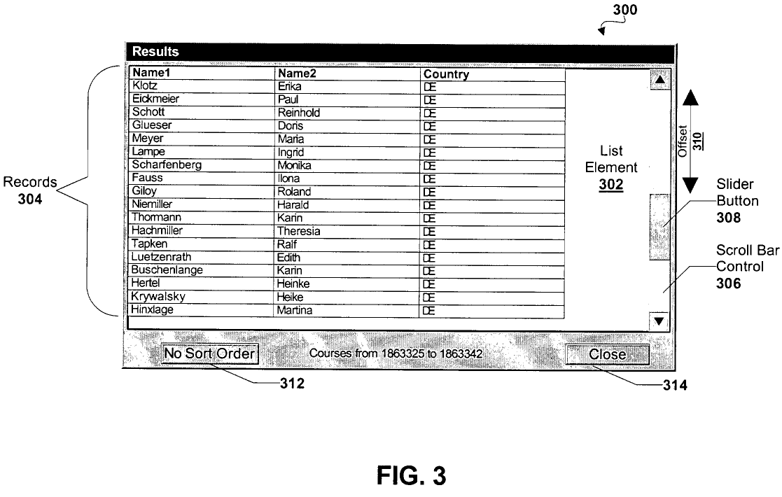

Referring to FIG. 3, a result window 300 includes a list element 302 used to display data records 304. When more data records 304 are selected than may be displayed in the list element 302, then a scroll bar control 306 is used to allow a user to scroll the matching records 304 through the visible portion of the list element 302. A user may select and move a slider button 308 up and down the scroll bar control 306 to scroll through the selected data records 304. When the slider button 308 is located at the very top of the scroll bar control 306, the first matching data records 304 are displayed in the list element 302. As the slider button 308 is moved down the scroll bar control 306, the offset 310 between the top of the slider bar control 306 and the slider button 308 is calculated and used to determine which record to begin display.

The list element 302 in the result window 300 may allow a user to scroll through matching data records 304 by loading the data records 304 into the list element 302. When the user actuates the slider button 308, the list element 302 updates the display of the data records 304 accordingly using the data records 304 stored by the list element 302. Alternatively, the list element 302 may simulate scrolling using the data store 204 described above by only loading the displayed data records into the list element 302 or by loading the data records into the list element 302 when they are needed to be displayed.

In FIG. 3, the result window 300 shows the result of selecting data records where the attribute “Country” is equal to “DE.” In this example, 1,863,342 data records match the query. This large quantity of data records could take significant resources to load into the list element 302. However, by using simulated scrolling, only displayed data records 304 are needed by the list element 302 to give the appearance that the user is scrolling through all 1,863,342 data records 304. FIG. 3 displays record numbers 1,863,325 to 1,863,342. These records may be transmitted from the data store 204 using the following SQL statement:

SELECT*FROM customer_data WHERE Country=“DE” LIMIT 1863325, 18.

When the displayed data is changed, the old displayed data may be discarded or may be retained by the list element 302 in case the user desires to display the data again.

The size of the slider button 308 is often indicative of the number of records loaded into the list element 302. If the slider button 308 is large, then fewer records are loaded. If the slider button 308 is very small, then a large number of records are loaded into the scroll bar control 306. When a list element 302 provides simulated scrolling, the list element 302 may determine the number of matching records and use that number to set the size of the slider button 308. If the data store 204 is augmented as described above, the data store 204 may determine the number of matching records in logarithmic time so that the size of the slider button 308 may be set.

Simulated scrolling gives the user only the illusion of scrolling or leafing through the whole result set of a selection, which may consist of millions of records. Using simulated scrolling, all matching records may not need to be transferred to the list element 302.

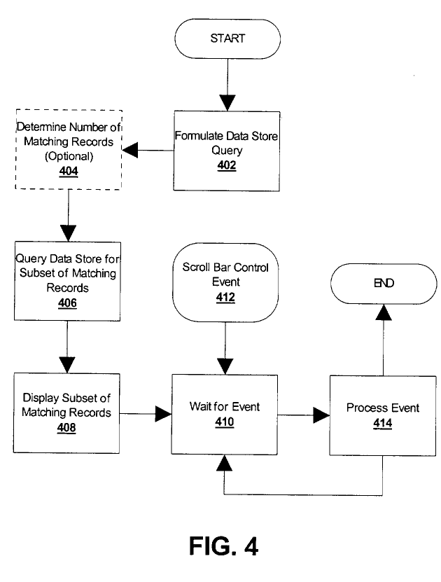

Referring to FIG. 4, simulated scrolling may be implemented by a simulated scrolling list element 302. The list element 302 loads only a portion of the matching records 304 using the process shown in FIG. 4. The system formulates a query of the data records kept in the data store 204 (step 402). If the simulated scrolling list element 302 sets the size of the slider button 308, then the system may determine the number of matching records by querying the data store 204 (step 404). The data store 204 may determine the number of records by augmenting an index tree structure as discussed above.

The system then obtains the records to be displayed by querying the data store for a subset of matching records (step 406). For example, if 15 records may be displayed at one time in a list element 302, then the system may query the data store 204 to return, for example, the first 15 matching data records 304. The subset of matching records 304 are then displayed in the list element 302 (step 408). Most GUI implementations are event driven. In other words, the system displays the appropriate data and then waits for events to occur, processing the events as they are received. The events may perform any function, including closing the GUI or updating a portion of the display. In this implementation, the system waits for an event (step 410). When a scroll bar control event 412 is received, the event 412 is processed (step 414). If the event 412 closes or otherwise ends the operation of the result window 300, then the process ends. Otherwise, the process continues to wait for another event (step 410).

The scroll bar control 306 may generate an event 412 when the slider button 308 is actuated. For example, a user may click on the slider button 308 using a mouse or other pointer device and slide the slider button 308 up or down the scroll bar control 306. When a new slider button 308 position is selected, the system determines the offset 310 and uses the offset 310 to update the list element 302 display. In some implementations, the offset 310 is represented as a number between 0 and 1. When the offset 310 is 0, then the first data records 304 are displayed. When the offset 310 is 1, then the last data records are displayed. When the offset 310 is between 0 and 1, then data records 304 are displayed based on the proportion of the offset between 0 and 1. For example, if there are 5 million records, then an offset of 0.1 causes data records 304 to be displayed beginning with 500,000.

In another implementation, the offset identifies the first displayed data record 304. For example, an offset of 1 displays the first data records 304 and an offset of 2,500,000 displays data records beginning with the 2,500,000^{th} data record 304.

A simulated scrolling list element 302 appears to function as a conventional list element without requiring that all data records be loaded into the list element 302. By loading only the displayed data records 304, the simulated scrolling list element 302 may increase the performance of the application by potentially reducing the communication resources needed.

A number of implementations have been described. Nevertheless, it will be understood that various modifications may be made. Accordingly, other implementations are within the scope of the following claims.

What is claimed is:

1. A user interface element for simulating scrolling comprising:
a display pane operable to display a visible set of data records, the visible set of data records including data records from a selected set of data records from a data store; and
a scroll bar control element corresponding to the display pane, the scroll bar control element operable to update the visible set of data records in response to a scroll bar control event,
wherein a subset of the selected set of data records are received by the user interface element.

2. The user interface element of claim 1 wherein the subset of the selected set of data records include only data records displayed in the display pane.

3. The user interface element of claim 1 wherein the scroll bar control element includes a slider button.

4. The user interface element of claim 3 wherein the size of the slider button is determined by the number of data records in the selected set of data records.

5. The user interface element of claim 4 wherein the number of data records is determined in logarithmic time.

6. The user interface element of claim 4 wherein the number of data records is determined using an augmented traversable tree structure.

7. The user interface element of claim 6 wherein each node of the traversable tree structure is augmented with a counter that may be used to determine the number of data records.

8. The user interface element of claim 1 wherein the selected set of data records is determined by executing a data store query.

9. A data query tool comprising:
a data store operable to store data records;
a data query software application operable to query the data store to identify data records satisfying a query statement; and
a user interface for displaying identified data records, the user interface including:
a display pane operable to display a visible set of data records, the visible set of data records including a subset of the identified data records; and
a scroll bar control element corresponding to the display pane, the scroll bar control element operable to update the visible set of data records in response to a scroll bar control event,
wherein a subset of the identified data records are received by the user interface.

10. The data query tool of claim 9 wherein the subset of the identified data records include only data records displayed in the display pane.

11. The data query tool of claim 9 wherein the scroll bar control element includes a slider button.

12. The data query tool of claim 11 wherein the size of the slider button is determined by the number of the identified data records.

13. The data query tool of claim 12 wherein the number of identified data records is determined in logarithmic time.

14. The data query tool of claim 12 wherein the number of identified data records is determined using an augmented traversable tree structure.

15. The data query tool of claim 14 wherein each node of the traversable tree structure is augmented with a counter usable to determine the number of identified data records.

16. The data query tool of claim 9 wherein the number of identified data records is determined by querying the data store.

17. A method for simulating scrolling in a graphical user interface, the method comprising:
providing a list pane operable to display a visible set of data records in a graphical user interface;
providing a scroll bar control element corresponding to the list pane, the scroll bar control element operable to update the visible set of data records in response to a scroll bar control event;
querying a data store to identify a set of data records satisfying a query statement;
receiving a subset of the identified data records, the subset including the visible set of data records; and
displaying the visible set of data records.

18. The method of claim 17 further comprising
waiting for a graphical user interface event; and
upon receiving a graphical user interface event, updating the visible set of data records in response to the received graphical user interface event.

19. The method of claim 17 wherein the subset of the identified data records include only data records displayed in the display pane.

20. The method of claim 17 further comprising receiving the number of identified data records.

21. The method of claim 20 wherein the number of identified data records is determined in logarithmic time.

22. The method of claim 20 wherein the number of identified data records is determined using an augmented traversable tree structure.
